(19) United States
(12) Patent Application Publication
(10) Pub. No.: US 2016/0365053 A1
(43) Pub. Date: Dec. 15, 2016

(54) Method of Controlling Data Display on Panel and Related Driving System

(71) Applicant: NOVATEK Microelectronics Corp., Hsin-Chu (TW)

(72) Inventors: Chin-Hung Hsu, Taoyuan City (TW); Te-Hsien Kuo, Keelung City (TW); Han-Ying Chang, Hsinchu City (TW)

(21) Appl. No.: 14/735,148

(22) Filed: Jun. 10, 2015

(51) Int. Cl. G09G 3/36

(52) U.S. Cl. CPC G09G 3/3677; G09G 3/3688; G09G 2330/021; G09G 2320/041; G09G 2310/08

(57) ABSTRACT

A method of controlling data display on a panel includes displaying a first row data by turning on a first scan line; comparing a plurality of row data with the first row data, to generate a comparison result; determining an order of displaying the plurality of row data according to the comparison result; and outputting the plurality of row data and turning on a plurality of scan lines corresponding to the plurality of row data in the order, to display the plurality of row data in the order.

### BACKGROUND OF THE INVENTION

1. Field of the Invention

The present invention relates to a method of controlling data display on a panel of a display device and a related driving system for the display device, and more particularly, to a method of dynamically controlling the order of displaying data on a panel of a display device and a related driving system for the display device.

2. Description of the Prior Art

A liquid crystal display (LCD), which is a flat panel display having the advantages of low radiation, light weight and low power consumption, is widely used in various information technology (IT) products such as notebook computers, personal digital assistants (PDA), and mobile phones. An active matrix thin film transistor (TFT) LCD is the most commonly used transistor type in LCD families, and particularly in the large-size LCD family. A driving system installed in the LCD includes a timing controller, source drivers and gate drivers. The source and gate drivers respectively control data lines and scan lines, which intersect to form a cell matrix. Each intersection is a cell including crystal display molecules and a TFT. In the driving system, the gate drivers are responsible for transmitting scan signals to gates of the TFTs to turn on the TFTs on the panel. The source drivers are responsible for converting digital image data, sent by the timing controller, into analog voltage signals and outputting the voltage signals to sources of the TFTs. When a TFT receives the voltage signals, a corresponding liquid crystal molecule has a terminal whose voltage changes to equalize the drain voltage of the TFT, which thereby changes its own twist angle. The rate that light penetrates the liquid crystal molecule is changed accordingly, allowing different colors to be displayed on the panel.

The normal operation always scans the scan lines on the LCD panel to turn on the TFTs row by row in a fixed order from up to down, and the data lines on the LCD panel are charged to specific voltage levels, to output the image data to the turned-on TFTs. In this manner, most power consumption of the LCD device is generated by charging the data lines. With increasing demands of large scale TFT LCD panels and high resolution requirements, more and more cells are included in an LCD panel; this increases power consumption much more. Thus, how to reduce power consumption of the LCD panel has become an important issue in this art.

### SUMMARY OF THE INVENTION

It is therefore an objective of the present invention to provide a method of controlling data display on a panel of a display device, in order to reduce power consumption of the display device.

The present invention discloses a method of controlling data display on a panel. The method comprises displaying a first row data by turning on a first scan line; comparing a plurality of row data with the first row data, to generate a comparison result; determining an order of displaying the plurality of row data according to the comparison result; and outputting the plurality of row data and turning on a plurality of scan lines corresponding to the plurality of row data in the order, to display the plurality of row data in the order.

The present invention further discloses a driving system for a display device. The driving system comprises a gate driver, at least one source driver and a timing controller. The gate driver is used for turning on a first scan line to display a first row data on a panel of the display device. The at least one source driver is used for outputting a plurality of row data after the first row data is displayed. The timing controller comprises a data comparison unit and a control unit. The data comparison unit is used for comparing the plurality of row data with the first row data, to generate a comparison result. The control unit is used for determining an order of displaying the plurality of row data according to the comparison result, and controlling the at least one source driver to output the plurality of row data and the gate driver to turn on a plurality of scan lines corresponding to the plurality of row data in the order.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display device according to an embodiment of the present invention.

FIG. 2 is a flowchart of a data display process according to an embodiment of the present invention.

FIG. 3 is a flowchart of a data display process according to an embodiment of the present invention.

FIG. 4 is a schematic diagram illustrating the comparison between a normal scan method and a scan method with row data reversion for power reduction.

FIG. 5 is a schematic diagram of a driving system for determining the data display order according to an embodiment of the present invention.

FIG. 6 is a schematic diagram of a normal scan method and a scan method with row data reversion where panel is divided into three regions.

FIG. 7 is a schematic diagram illustrating the comparison between a normal scan method and a scan method with row data reversion for power reduction.

### DETAILED DESCRIPTION

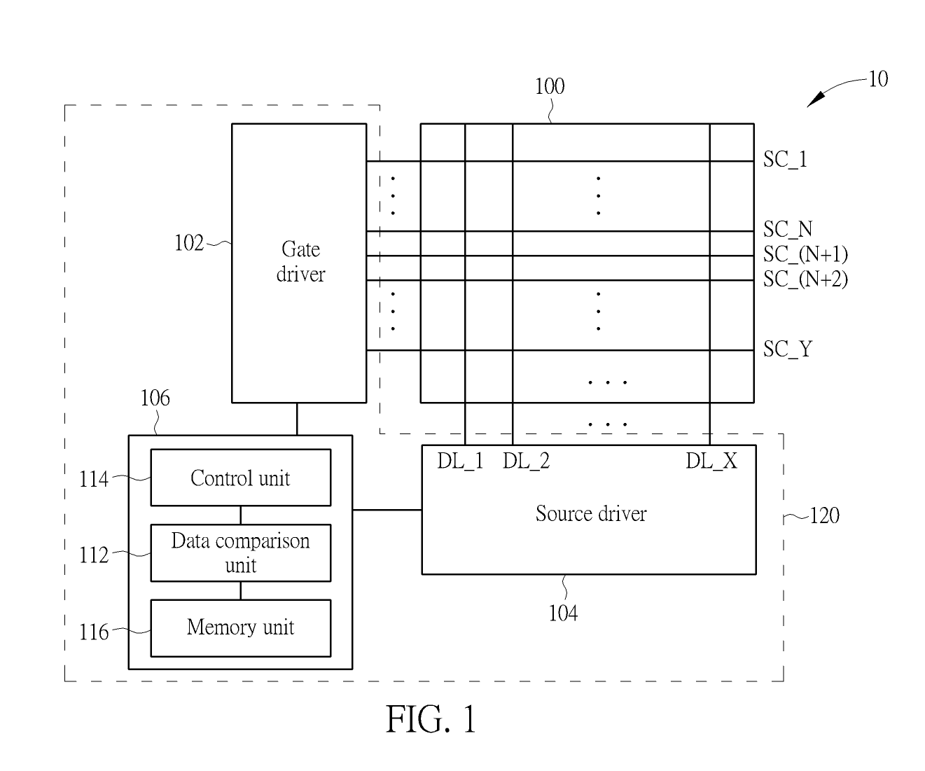

Please refer to FIG. 1, which is a schematic diagram of a display device 10 according to an embodiment of the present invention. As shown in FIG. 1, the display device 10 includes a panel 100 and a driving system 120. The display device 10 may be a liquid crystal display (LCD) device or other type of display device. The driving system 120, which is used for controlling data display on the panel 100, includes a gate driver 102, a source driver 104 and a timing controller 106. The gate driver 102 is used for outputting gate driving signals via the scan lines SC_1-SC_Y of the panel 100, to turn on the transistors on the panel 100 row by row, allowing the turned-on transistors to receive display data. The source driver 104 is used for outputting voltage signals as image data to the data lines DL_1-DL_X. The timing controller 106 is used for controlling the gate driver 102 and the source driver 104. In detail, the timing controller 106 controls the gate driver 102 to turn on the transistors row by row, and controls the source driver 104 to output data corresponding to the turned-on transistors in each row in order, to display the image data via the transistors in each row. For example, a general display operation may start from the scan line SC_1, and then go through the scan lines SC_2, SC_3, SC_4, . . . , until the last row (i.e., the scan line SC_Y) to complete a cycle. After the image data corresponding to the scan line SC_Y is displayed, the display operation then repeats from the first row (i.e., the scan line SC_1) in the next cycle.

Please note that in a driving system of a display device such as the driving system 120, most power consumption originates from charging of the data lines. Larger data variations may usually need more electric charge quantity, and thereby consumes more power. Therefore, in order to reduce power consumption by reducing the degree of data variations, the present invention detects the data variations and changes the order of displaying row data.

Please keep referring to FIG. 1. The timing controller 106 includes a data comparison unit 112, a control unit 114 and a memory unit 116. The data comparison unit 112 is used for comparing the row data, in order to determine data variations between the latest displayed row data and other row data to be displayed later. The control unit 114 is used for determining the order of displaying the row data according to the comparison result generated from the data comparison unit 112. The control unit 114 then controls the gate driver 102 and the source driver 104 to display the subsequent data in this order. The memory unit 116 is used for storing the row data to be compared. In this manner, the timing controller 116 may control the source driver 104 to output the subsequent row data in a specific order and control the gate driver 102 to turn on the subsequent scan lines correspondingly, in order to decrease data variations and thereby reduce power consumption.

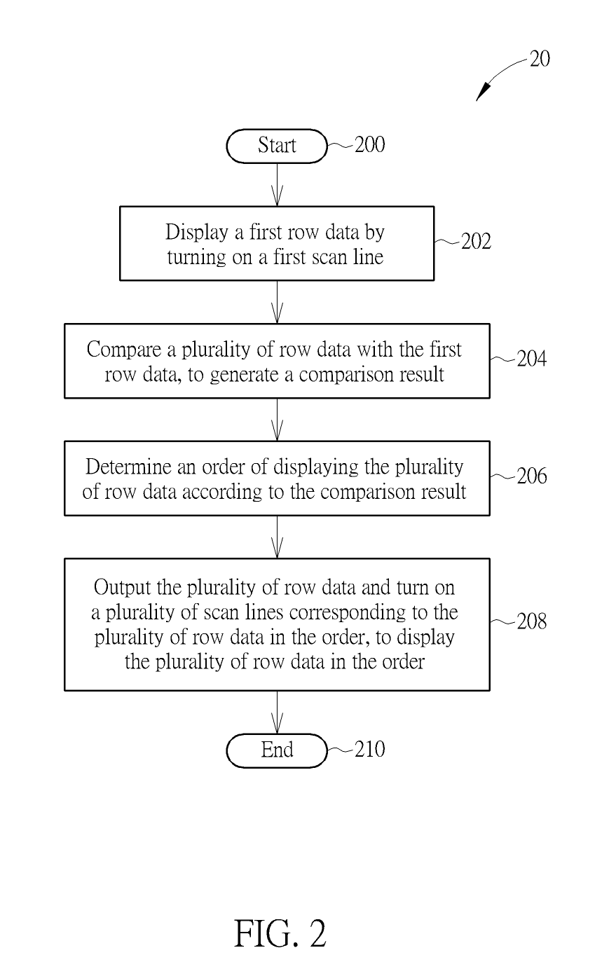

Please refer to FIG. 2, which is a flowchart of a data display process 20 according to an embodiment of the present invention. The data display process 20 may be used for a driving system of a display device, such as the driving system 120 shown in FIG. 1, for controlling data display on the panel 100. The data display process 20 may be implemented in the driving system 120 and includes the following steps:

Step 200: Start.

Step 202: Display a first row data by turning on a first scan line.

Step 204: Compare a plurality of row data with the first row data, to generate a comparison result.

Step 206: Determine an order of displaying the plurality of row data according to the comparison result.

Step 208: Output the plurality of row data and turn on a plurality of scan lines corresponding to the plurality of row data in the order, to display the plurality of row data in the order.

Step 210: End.

According to the data display process 20, the panel 100 first displays a first row data when the gate driver 102 turns on a first scan line. The data comparison unit 112 compares a plurality of row data to be displayed with the first row data, to generate a comparison result. The control unit 114 then determines an order of displaying the plurality of row data according to the comparison result, where the display order may lead to fewer data variations and thereby generate lower power consumption. Accordingly, the source driver 104 will output the plurality of row data in this order, and the gate driver 102 will turn on the plurality of scan lines corresponding to the plurality of row data in this order, so that the plurality of row data are displayed in this order.

More specifically, the control unit 114 may determine a difference between each of the plurality of row data and the first row data by comparing each of the plurality of row data with the first row data, respectively. In this manner, the control unit 114 is able to find out a row data most similar to the first row data (i.e., the row data with a smaller difference to the first row data) from the plurality of row data, and the panel 100 displays this row data after the first row data is displayed. The panel 100 then displays a row data secondarily similar to the first row data. Among the plurality of row data, a row data having a smaller difference to the first row data is displayed earlier than another row data having a larger difference to the first row data, in order to minimize power consumption. For example, the gate driver may turn on a second scan line among the plurality of scan lines to display a second row data among the plurality of row data before turning on a third scan line among the plurality of scan lines to display a third row data among the plurality of row data when the difference between the second row data and the first row data is less than the difference between the third row data and the first row data.

In an embodiment, the timing controller 106 may control the panel 100 to display a row data D0 in the scan line SC_N and then determine that a row data D1 in the scan line SC_(N+1) or a row data D2 in the scan line SC_(N+2) will be displayed following the row data D0. The data comparison unit 112 then compares the row data D1 and D2 with the latest displayed row data D0. In detail, the data comparison unit 112 compares the row data D1 with the row data D0 and finds out the difference between the row data D1 and the row data D0. The data comparison unit 112 also compares the row data D2 with the row data D0 and finds out the difference between the row data D2 and the row data D0. If the difference between the row data D1 and the row data D0 is less than the difference between the row data D2 and the row data D0, the panel 100 displays the row data D1 before displaying the row data D2. If the difference between the row data D2 and the row data D0 is less than the difference between the row data D1 and the row data D0, the panel 100 displays the row data D2 before the row data D1. In contrast to the conventional display device where the row data are always displayed in a fixed order from up to down, the present invention may change the display order, e.g., reverse the order of displaying the row data D1 and D2, to reduce power consumption since the row data with a smaller difference are displayed successively to reduce the amounts of charging and discharging in data lines.

Please note that when the source driver 104 outputs the row data based on the order determined by the timing controller 106, the gate driver 102 may also turn on the scan lines in this order correspondingly. For example, if the source driver 104 outputs the row data in an order of D0, D1 and D2, the gate driver 102 may correspondingly turn on the scan lines in an order of SC_N, SC_(N+1) and SC_(N+2), to display the row data D0, D1 and D2. If the source driver 104 outputs the row data in an order of D0, D2 and D1, where the row data D2 is displayed before the row data D1 since the row data D2 has a smaller difference to the row data D0, the gate driver 102 may correspondingly turn on the scan lines in an order of SC_N, SC_(N+2) and SC_(N+1), to display the row data D0, D2 and D1. That is, in contrast to the conventional data display method where image data is always displayed from up to down, the order of displaying the row data D1 and D2 may be reversed if the reversion leads to reduction of power consumption.

After the plurality of compared row data are displayed, the row data last displayed among the plurality of row data will become the latest row data, which is further compared with a subsequent plurality of row data. More specifically, in the above embodiment, if the panel 100 displays the row data in an order of D0, D1 and D2, the row data D2 will become the latest row data and will be compared with the row data in the scan lines SC_(N+3), SC_(N+4) or other subsequent data lines. If the panel 100 displays the row data in an order of D0, D2 and D1, the row data D1 will become the latest row data and will be compared with the row data in the scan lines SC_(N+3), SC_(N+4) or other subsequent data lines. In this manner, the timing controller 106 may determine the display order in every two row data (or more than two row data), and the panel 100 may display the row data in an order with less data variation or difference in the data lines. This generates less power consumption in every two (or more) row data, and may bring about significant power reduction in image display.

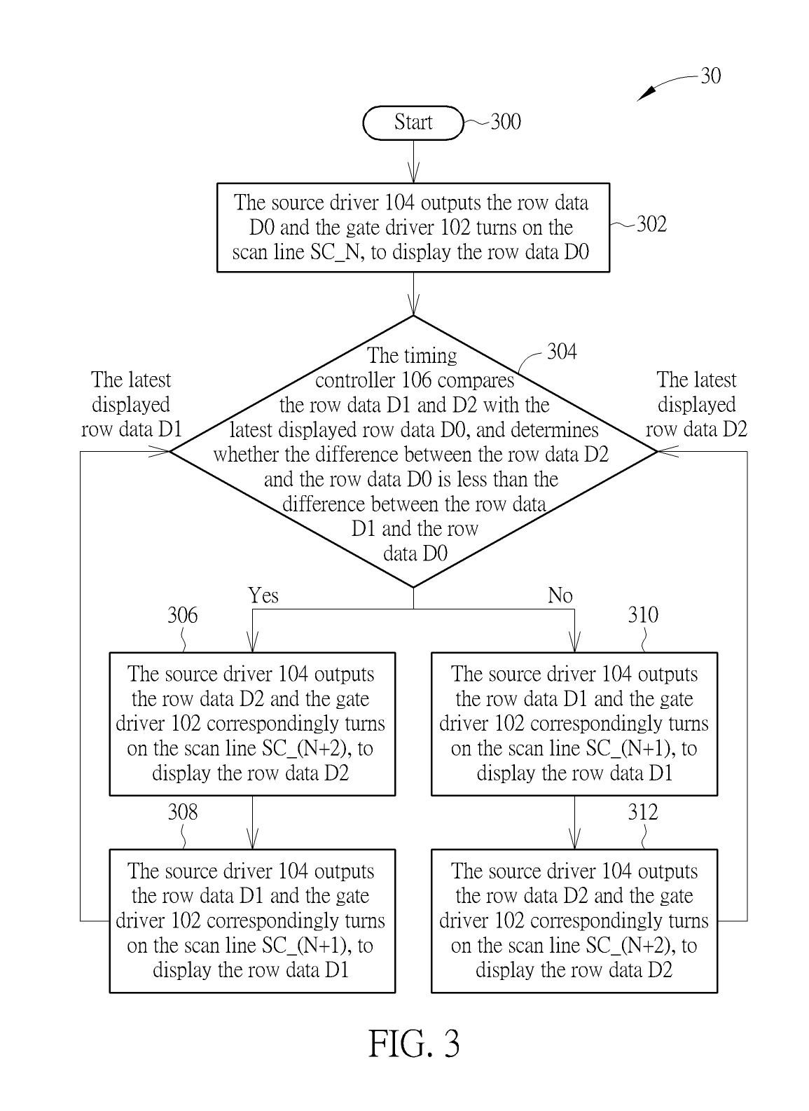

The abovementioned operations of comparing the row data D1 and D2 with the row data D0 to determine the display order may be summarized into a data display process 30, as shown in FIG. 3. The data display process 30 may be implemented in the driving system 120 and includes the following steps:

Step 300: Start.

Step 302: The source driver 104 outputs the row data D0 and the gate driver 102 turns on the scan line SC_N, to display the row data D0.

Step 304: The timing controller 106 compares the row data D1 and D2 with the latest displayed row data D0, and determines whether the difference between the row data D2 and the row data D0 is less than the difference between the row data D1 and the row data D0. If yes, go to Step 306; otherwise, go to Step 310.

Step 306: The source driver 104 outputs the row data D2 and the gate driver 102 correspondingly turns on the scan line SC_(N+2), to display the row data D2.

Step 308: The source driver 104 outputs the row data D1 and the gate driver 102 correspondingly turns on the scan line SC_(N+1), to display the row data D1, and go to Step 304 to compare the latest displayed row data D1 with subsequent row data.

Step 310: The source driver 104 outputs the row data D1 and the gate driver 102 correspondingly turns on the scan line SC_(N+1), to display the row data D1.

Step 312: The source driver 104 outputs the row data D2 and the gate driver 102 correspondingly turns on the scan line SC_(N+2), to display the row data D2, and go to Step 304 to compare the latest displayed row data D2 with subsequent row data.

In this manner, every two scan lines and the corresponding row data may be classified into a group, and compared with the latest displayed row data. The data display process 30 may be performed in each group, allowing the row data in each group to be displayed in an order so that the data lines possess smaller amounts of charging and discharging, which bring about less power consumption. Please note that a group may also include more than two row data and corresponding scan lines, to achieve further improvements in power reduction, where the number of row data included in a group should be controlled without influencing the quality of displayed image and increasing the cost excessively.

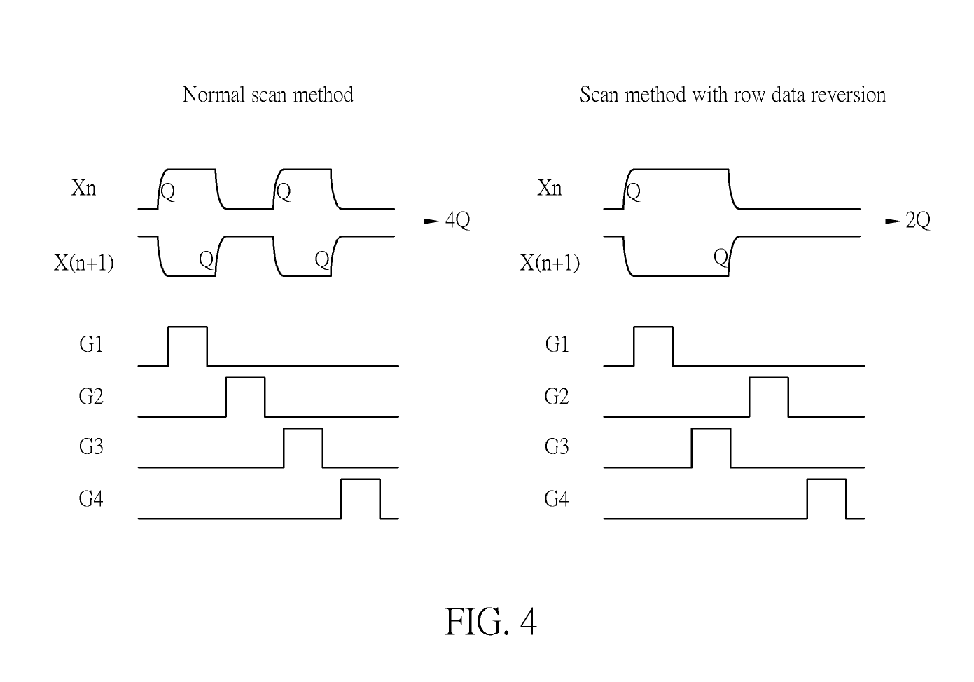

Please refer to FIG. 4, which is a schematic diagram illustrating the comparison between a normal scan method and a scan method with row data reversion, wherein the row data reversion may bring about less power consumption. FIG. 4 illustrates a data pattern in positive polarity and negative polarity outputted to two adjacent data lines, as denoted by Xn and X(n+1), respectively, and gate driving signals G1-G4 for respectively driving four adjacent scan lines such as the scan lines SC_1-SC_4 shown in FIG. 1. Electric power is required when data is charged from a lower voltage level to a higher voltage level, and Q denotes an amount of power consumed by charging the data lines.

As illustrated by the normal scan method shown in FIG. 4, the gate driver triggers the gate driving signals G1-G4 to drive the scan lines in a normal order, i.e., in an order of G1, G2, G3 and G4. In such a condition, the data pattern Xn and X(n+1) consumes a power amount equal to 4Q. On the other hand, when the data display method for reducing power consumption is applied, the timing controller may determine whether to reverse the order of displaying the second and third data, i.e., data corresponding to the gate driving signals G2 and G3. After performing the comparison between these data and the displayed data, i.e., data corresponding to the gate driving signal G1, the timing controller controls the source driver to reverse the order of outputting the second and third data; that is, output the third data earlier than the second data. The timing controller correspondingly controls the gate driver to trigger the gate driving signal G3 before the gate driving signal G2. Therefore, according to the scan method for reducing power consumption with the data display process and method mentioned above, the power amount consumed by the data pattern Xn and X(n+1) is reduced to 2Q, which means 50% reduction in transient power on the data lines.

Please note that in the above embodiments, the comparison between row data is performed on the entire row data. In several embodiments, the comparison between row data is performed on partial row data. More specifically, the panel may be divided into several regions, and the comparison of row data is performed with the partial row data located in each region. Therefore, the difference between the row data to be displayed and the latest displayed row data in each region is determined, respectively.

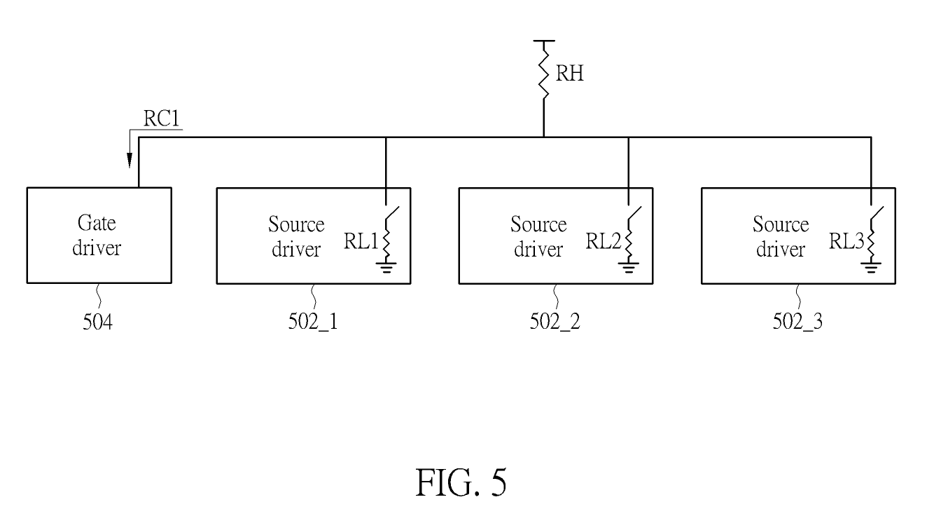

For example, please refer to FIG. 5, which is a schematic diagram of a driving system 50 for determining the data display order according to an embodiment of the present invention. As shown in FIG. 5, the driving system 50 includes source drivers 502_1-502_3, a gate driver 504 and a resistor RH. The source driver 502_1 includes a resistor RL1, the source driver 502_2 includes a resistor RL2, and the source driver 502_3 includes a resistor RL3. A control terminal is connected to the resistors RH and RL1-RL3, to output a reverse control signal RC1 to the gate driver 504 to determine the order of displaying row data (or to determine whether to reverse the original order of displaying row data).

In detail, the order of displaying the row data is determined by incorporating the differences between each row data to be displayed and the latest displayed row data in different regions. In an embodiment, the differences obtained in all regions are obtained to determine whether to reverse the order of displaying two row data such as the row data D1 and D2 shown in FIG. 3. As shown in FIG. 5, the resistance values of the resistors RH and RL_1-RL_3 may be configured to allow the reverse control signal RC1 to reverse the order when at least two of the resistors RL_1-RL_3 indicate that the reversion will lead to less power consumption. In this case, the driving system 50 may include a plurality of data comparison units, a plurality of control units and a plurality of memory units, each of which is included in one of the source drivers 502_1-502_3.

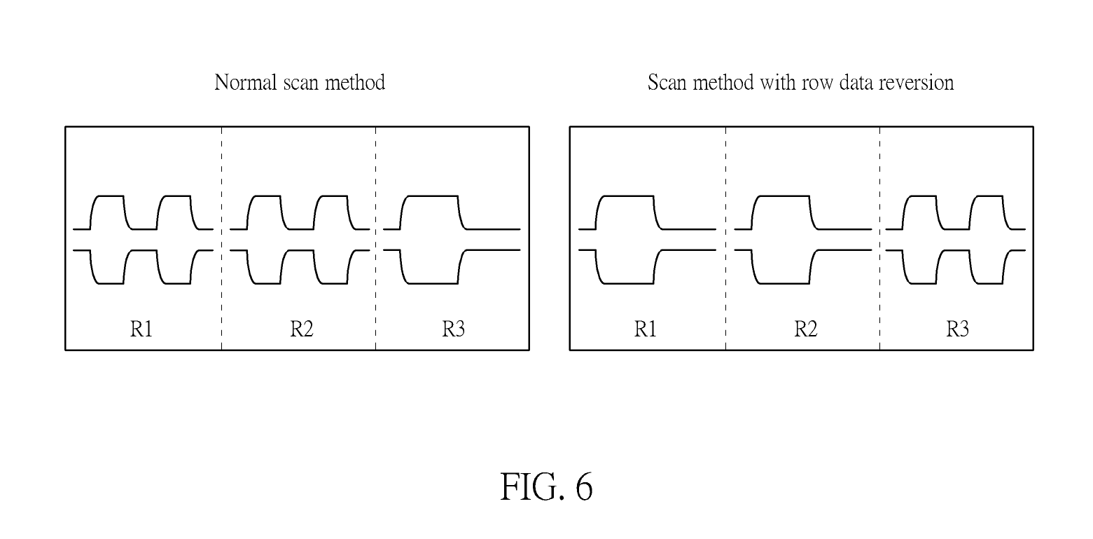

Please refer to FIG. 6, which is a schematic diagram of a normal scan method and a scan method with row data reversion where the panel is divided into three regions R1-R3. As shown in FIG. 6, for specific scan lines, the normal scan method has more data variations (i.e., more charging and discharging operations) on data lines in the regions R1 and R2 and fewer data variations (i.e., less charging and discharging operations) on data lines in the region R3, and the scan method with row data reversion has fewer data variations (i.e., less charging and discharging operations) on data lines in the regions R1 and R2 and more data variations (i.e., more charging and discharging operations) on data lines in the region R3. According to embodiments of the present invention, the row data reversion is applied since two of the regions R1-R3, as a majority, have fewer data variations. Note that in other embodiments, a panel may include only two regions or more than three regions, and row data reversion may be applied if a majority of the regions indicate that the row data reversion will generate fewer data variations and thereby reduce power consumption.

Please note that the current trend of LCD panel is large scale and high resolution, which requires more source drivers to drive a larger number of data lines. Therefore, it is preferable to include more source driver integrated circuits (ICs) in a driving system of an LCD, where each driver IC is responsible for a part of data lines in partial area of the panel. In such a condition, the panel is divided into multiple regions based on the allocation of data lines thereon to each driver IC. In other words, the number of regions may be equal to the number of source drivers implemented in a driving system, and each region is corresponding to one source driver.

In this case, the order of displaying the row data may be determined by considering partial or all of the source driver ICs. In other words, each of the source drivers is able to determine whether to perform row data reversion in order to meet specific requirements. For example, each of the source driver ICs may include a temperature sensor to detect the temperature in the corresponding region. If the temperature detected by one or several source driver ICs exceeds a predetermined level to be regarded as an over-temperature condition, only the region(s) corresponding to this (these) source driver IC(s) is considered to determine whether to perform row data reversion. That is, the order of displaying the row data is determined by incorporating the differences between each of the row data to be displayed and the latest displayed row data only in the region(s) where over-temperature occurs.

Please keep referring to FIG. 6 with the circuit structure shown in FIG. 5. If the differences between each row data to be displayed and the latest displayed row data in all of the regions R1-R3 are considered, the scan method with row data reversion is applied since a majority of regions (i.e., the regions R1 and R2) indicate that row data reversion is preferable for power consumption reduction. After several cycles of row data comparisons and display order determinations, the temperature sensor in the source driver 502_3 corresponding to the region R3 may detect that the temperature exceeds a predetermined level since the data lines in the region R3 may undergo a higher degree of charging and discharging. After over-temperature occurs in the region R3, the order of displaying the row data may be determined by comparisons of the part of row data located in the region R3 in subsequent several cycles or until the over-temperature condition is relieved. For example, with the data pattern shown in FIG. 6, the row data reversion may not be performed for several cycles to reduce power consumption in the region R3 and thereby reduce the temperature of the source driver 502_3 and the corresponding area on the panel.

Please note that the present invention aims at reducing power consumption of a display device by reducing transient power on data lines, which is achieved by dynamically controlling the order of displaying data lines on the panel to allow data lines with less data difference to be displayed successively, so that the electric power for charging the data lines can be decreased. Based on the above operations, those skilled in the art may perform modifications and alternations according to system requirements. For example, the number of row data compared with the latest displayed row data may be two, three or any possible number. The panel may be divided into any number of regions, based on the number of source driver ICs implemented in the driving system or due to other reasons; this should not be limited herein. Furthermore, the circuit structure implemented with the resistors shown in FIG. 5 is only one of various embodiments where the data display order is determined in multiple source drivers. The source drivers may output the reverse control signal in other manners, which are not limited to the circuit structure described herein.

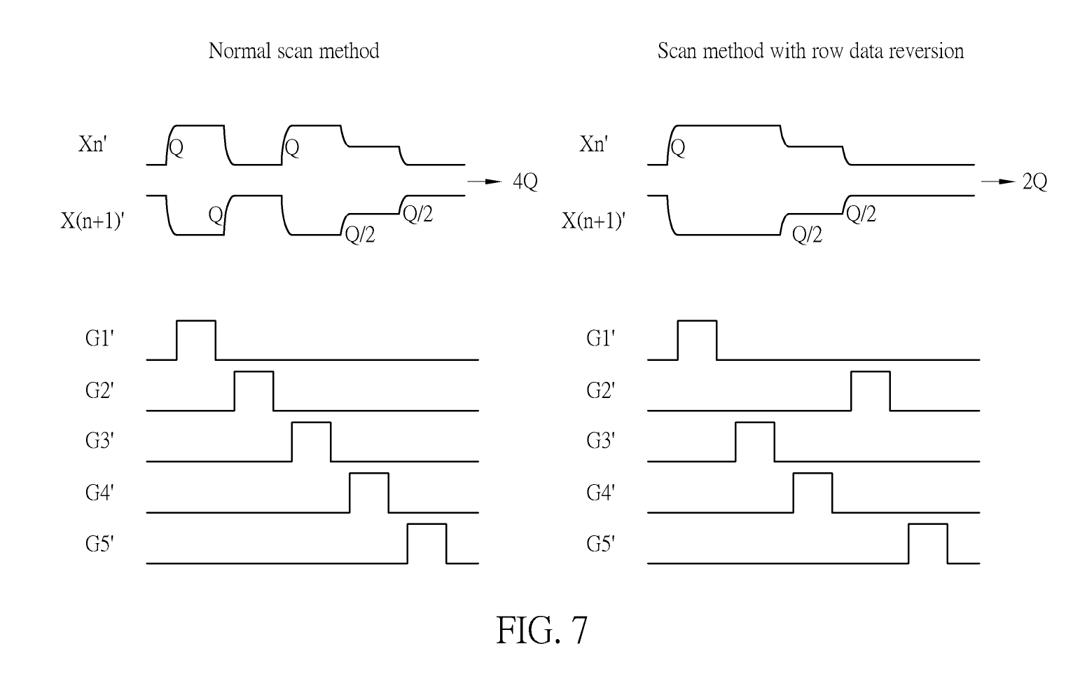

Please refer to FIG. 7, which is a schematic diagram illustrating the comparison between a normal scan method and a scan method with row data reversion for power reduction, where the row data reversion is implemented via comparisons of three row data. FIG. 7 illustrates another data pattern in positive polarity and negative polarity outputted to two adjacent data lines, as denoted by Xn′ and X(n+1)′, respectively, and gate driving signals G1′-G5′ for respectively driving five adjacent scan lines such as the scan lines SC_1-SC_5 shown in FIG. 1. Electric power is required when data is charged from a lower voltage level to a higher voltage level. The data pattern shown in FIG. 7 includes three voltage levels, where charging from the lowest voltage level to the highest voltage level requires a power amount Q, and charging from the lowest voltage level to the middle voltage level or from the middle voltage level to the highest voltage level requires a power amount Q/2.

As illustrated by the normal scan method shown in FIG. 7, the gate driver triggers the gate driving signals G1′-G5′ to drive the scan lines in a normal order, i.e., in an order of G1′, G2′, G3′, G4′ and G5′. In such a condition, the data pattern Xn′ and X(n+1)′ consumes a power amount equal to 4Q. On the other hand, when the data display method for reducing power consumption is applied, the timing controller may determine whether to reverse the order of displaying the second, third and fourth data, i.e., data corresponding to the gate driving signals G2′, G3′ and G4′. After performing the comparison between these data and the displayed data, i.e., data corresponding to the gate driving signal G1, the timing controller controls the source driver to output the row data in an order of G3′, G4′ and G2′, in order to minimize power consumption. The timing controller correspondingly controls the gate driver to trigger the gate driving signals G3′ and G4′ before the gate driving signal G2′. Therefore, according to the scan method for reducing power consumption implemented with the data display process and method mentioned above, the power amount consumed by the data pattern Xn′ and X(n+1)′ is reduced to 2Q, which means 50% reduction in transient power on the data lines.

In the prior art, the normal operation always scans the scan lines on the LCD panel to turn on the TFTs row by row in a fixed order from up to down, and the data lines on the LCD panel are charged to specific voltage levels, to output the image data. Most power consumption of the LCD device is generated by charging the data lines. The trend of large scale and high resolution in LCD panels is accompanied by more and more power consumption. Therefore, the present invention provides a method of controlling data display on a panel of a display device and the driving system driving the display device. According to embodiments of the present invention, several row data to be displayed are compared with the latest displayed row data, to obtain the difference between each of the row data to be displayed and the latest displayed row data. Therefore, the row data having a smaller difference to the latest displayed row data will be displayed earlier than those having a larger difference to the latest displayed row data. In such a condition, the row data with fewer data variations are displayed successively, which reduces the amounts of charging and discharging operations included in data lines, and thereby reduces power consumption. As a result, the interchange or reversion of the display order of row data may lead to reduction of power consumption after the comparisons between row data are performed. Furthermore, the panel may be divided into several regions, and the comparison of row data is performed in each region. Therefore, the difference between the row data to be displayed and the latest displayed row data located in each region is determined, respectively, and the comparison result in each region is considered to prevent occurrence of over-temperature in specific region(s).

Those skilled in the art will readily observe that numerous modifications and alterations of the device and method may be made while retaining the teachings of the invention. Accordingly, the above disclosure should be construed as limited only by the metes and bounds of the appended claims.

1. A method of controlling data display on a panel, comprising:
displaying a first row data by turning on a first scan line;
comparing a plurality of row data with the first row data, to generate a comparison result;
determining an order of displaying the plurality of row data according to the comparison result; and
outputting the plurality of row data and turning on a plurality of scan lines corresponding to the plurality of row data in the order, to display the plurality of row data in the order.

2. The method of claim 1, wherein the step of comparing the plurality of row data with the first row data to generate the comparison result comprises:
determining a difference between each of the plurality of row data and the first row data by comparing each of the plurality of row data with the first row data, respectively.

3. The method of claim 2, wherein the step of outputting the plurality of row data and turning on the plurality of scan lines corresponding to the plurality of row data in the order to display the plurality of row data in the order comprises:
among the plurality of row data, displaying a row data having a smaller difference to the first row data earlier than another row data having a larger difference to the first row data.

4. The method of claim 1, further comprising:
dividing the panel into a plurality of regions, and comparison of the plurality of row data is performed with partial row data located in each of the plurality of regions.

5. The method of claim 4, wherein the step of comparing the plurality of row data with the first row data to generate the comparison result further comprises:
determining a difference between each of the plurality of row data and the first row data in each of the plurality of regions, respectively.

6. The method of claim 5, wherein the order of displaying the plurality of row data is determined by incorporating the differences between each of the plurality of row data and the first row data in the plurality of regions.

7. The method of claim 5, wherein the order of displaying the plurality of row data is determined by incorporating the differences between each of the plurality of row data and the first row data in at least one of the plurality of regions when a temperature in the at least one region exceeds a predetermined level.

8. A driving system for a display device, comprising:
a gate driver, for turning on a first scan line to display a first row data on a panel of the display device;
at least one source driver, for outputting a plurality of row data after the first row data is displayed; and
a timing controller, comprising:
a data comparison unit, for comparing the plurality of row data with the first row data, to generate a comparison result; and
a control unit, for determining an order of displaying the plurality of row data according to the comparison result, and controlling the at least one source driver to output the plurality of row data and the gate driver to turn on a plurality of scan lines corresponding to the plurality of row data in the order.

9. The driving system of claim 8, wherein the timing controller determines a difference between each of the plurality of row data and the first row data by comparing each of the plurality of row data with the first row data, respectively.

10. The driving system of claim 9, wherein among the plurality of row data, a row data having a smaller difference to the first row data is displayed earlier than another row data having a larger difference to the first row data.

11. The driving system of claim 8, wherein the panel is divided into a plurality of regions, and comparison of the plurality of row data is performed with partial row data located in each of the plurality of regions.

12. The driving system of claim 11, wherein a difference between each of the plurality of row data and the first row data in each of the plurality of regions is determined, respectively.

13. The driving system of claim 12, wherein the order of displaying the plurality of row data is determined by incorporating the differences between each of the plurality of row data and the first row data in the plurality of regions.

14. The driving system of claim 12, wherein the at least one source driver comprises a plurality of source drivers, and each of the plurality of regions corresponds to one of the plurality of source drivers;
wherein each of the plurality of source drivers comprises a temperature sensor to detect a temperature in a corresponding region among the plurality of regions.

15. The driving system of claim 14, wherein the order of displaying the plurality of row data is determined by incorporating the differences between each of the plurality of row data and the first row data in at least one of the plurality of regions when the temperature in the at least one region exceeds a predetermined level.
